(19) United States
(12) Patent Application Publication
(10) Pub. No.: US 2018/0331401 A1
(43) Pub. Date: Nov. 15, 2018

(54) ENERGY STORAGE DEVICE

(71) Applicant: AUDI AG, Ingolstadt (DE)

(72) Inventor: Thomas GLASS, Mainburg (DE)

(73) Assignee: AUDI AG, Ingolstadt (DE)

(21) Appl. No.: 15/773,326

(22) PCT Filed: Oct. 21, 2016
(86) PCT No.: PCT/EP2016/075445

§ 371 Date: May 3, 2018

(30) Foreign Application Priority Data
Nov. 10, 2015 (DE) 10 2015 222 138.5

(51) Int. Cl. H01M 10/613; H01M 10/6556; B60L 11/18

(52) U.S. Cl. CPC H01M 10/613; H01M 10/6556; H01M 2220/20; B60L 11/1874; B60L 11/1879

(57) ABSTRACT

An energy storage device with a housing with one or a plurality of storage cells or storage cell modules accommodated in it as well as one or a plurality of coolant lines, through which flows a coolant, flowing by way of a coolant circuit. The one or the plurality of coolant lines is or are integrated into one or a plurality of walls of the housing and extends or extend without interruption on the housing side, from an inlet connection lying outside of the housing to an outlet connection likewise lying outside of the housing.

The invention relates to an energy storage device comprising a housing with one or a plurality of storage cells or storage cell modules accommodated in it as well as one or a plurality of coolant lines, through which flows a coolant, flowing by way of a coolant circuit.

Energy storage devices of this kind are provided, for example, for motor vehicles in order to create an electric drive. The motor vehicle can be a purely electric vehicle or else a hybrid vehicle comprising an electric drive as well as an internal combustion engine drive. Energy storage devices of this kind are also referred to as high-voltage batteries, because they usually supply voltages of several 100 V.

Because such an energy storage device heats up during operation, it is necessary to cool it. For this purpose, either air is used or else a fluid coolant or refrigerant—for example, also in the form of a water-glycol mixture—is used. When such a fluid refrigerant is used and, in particular, when a water-glycol mixture is used, leakage within the housing in which the storage cells or storage cell modules are accommodated is necessarily to be prevented on account of the electrical conductivity. For this reason, careful attention is paid to the connections of the coolant lines in the interior of the housing being completely leaktight. In the event of leakage, short circuits can result within the energy storage device, that is, the high-voltage battery, in association with a high fire potential. Accordingly, a great effort is made to ensure the leaktightness of the line connections, but, problems cannot be fully excluded.

The invention is thus based on the object of presenting an energy storage device that is improved in this respect.

Proposed for achieving this object is that, for an energy storage device of the kind mentioned in the introduction, it is provided that the one or the plurality of coolant lines is or are integrated into one or a plurality of walls of the housing and extend on the housing side without interruption from an inlet connection lying outside of the housing to an outlet connection also lying outside of the housing.

In the energy storage device according to the invention, all line connections are provided outside of the closed housing, so that, consequently, leakage cannot occur in the interior of the housing. Moreover, the one or the plurality of coolant lines is or are integrated into one or a plurality of walls of the housing, and are therefore a fixed, inseparable part of the housing, so that even any leakages over the length of a coolant line itself are excluded. Therefore, special measures relating to the sealing of connection points do not need to be taken beyond what is normal, because leakages in the interior of the housing are excluded from the housing itself. As a result, any problems resulting from this, such as short circuits and the like, are effectively prevented.

In accordance with a first alternative of the invention, it can be provided that the one or the plurality of coolant lines is or are formed by pipes, which are embedded completely in the one or the plurality of walls. The pipes can be plastic or metal pipes depending on the material of the wall or walls. If the housing walls are made of plastic, then it is possible to use both plastic pipes and metal pipes that, in a corresponding casting or injection molding operation, are embedded completely in the wall fabricated from plastic. If the wall or walls is or are made of metal, which is generally the case for forming high-voltage battery housings, then metal pipes that are cast in the wall material, for example, are likewise used.

In accordance with a first variant of the invention, the pipes can extend in a U-shape in the wall and open only at one side, wherein the one pipe end forms an inlet connection and the other pipe end forms an outlet connection, wherein the pipe ends of two, preferably adjacent pipes are connected to each other via connecting pipe pieces arranged outside of the housing. Therefore, all pipe ends open at a common wall side, wherein the pipes extend substantially parallel to the other wall side, where, in turn, they are directed back via a U-shaped bend. The connecting pipe pieces are consequently provided only at one wall side, wherein the individual pipe ends are connected to one another in a meandering shape via the connecting pipe pieces, so that a meandering cooling pipe coil is created inside of the wall. The connecting pipe pieces can be made of metal or plastic, wherein they need not necessarily be made of the same material as the pipes embedded in the wall.

Alternatively, in accordance with a second variant of the invention, it can be provided that the pipes extend in a straight line in the wall and open at both sides, wherein the one pipe end forms an inlet connection and the other pipe end forms an outlet connection, wherein the pipe ends of two, preferably adjacent pipes are connected to each other via connecting pipe pieces arranged outside of the housing. In this case, all pipes extend only in a straight line inside of the respective wall and open at both sides, so that, at both wall sides, corresponding connecting pipe pieces are to be arranged. Said connecting pipe pieces are positioned offset with respect to one another to form a cooling pipe coil that passes through in a meandering shape. Each connecting pipe connects a pipe end of a first pipe to, for example, the adjacent pipe end of an adjacent pipe, wherein the one pipe end forms an outlet connection and the other pipe end forms an inlet connection, so that the coolant leaving the one pipe can flow into the other pipe end via the connecting pipe. At the opposite-lying wall side, another corresponding connection is created via a connecting pipe piece, so that a cooling pipe coil is obtained.

Alternatively, for the use of separate pipes, which are cast or embedded, respectively, in the wall material, it is also conceivable to form the walls by means of extruded profiles with one or a plurality of cavities, wherein the cavity or cavities forms or form the coolant lines. In accordance with this embodiment of the invention, therefore, extruded profiles, that is, plate-shaped pressed profiles that have one or a plurality of cavities through which the coolant flows, are used for formation of the cooling walls. Similarly to the case for the creation of walls furnished with pipes, it is only necessary, of course, to use extruded profiles to form the walls that are to be cooled. The extruded profiles can, in turn, be made of plastic or metal, wherein, in particular for high-voltage batteries, metal extruded profiles are used in order to ensure an adequate housing stability.

Due to their manufacture, the cavities extend in a straight line through the extruded profile and therefore end at both wall sides, wherein, in this case, too, the one end of the cavity forms an inlet connection and the other end of the cavity forms an outlet connection. The cavity ends of two cavities are connected to each other, in turn, via connecting pipe pieces arranged outside of the housing, so that, when such an extruded profile is used, it is also possible to form a coolant line coil extending in a meandering shape through the wall. In this case, too, it is possible to use, as connecting pipe pieces, those made of plastic or metal, wherein, in turn, the kind of material of the connecting pipe pieces can differ from that of the extruded profile.

For formation of a larger energy storage device, a housing with a plurality of levels is often used, in each of which one or a plurality of storage cells or storage cell modules is or are arranged. Provided in accordance with the invention are then one or a plurality of coolant lines in each level, which, in turn, are connected to one another outside of the housing in the coolant circuit. This means that, ultimately, each level is composed of at least one wall with, for example, cast pipes or else is composed of an extruded profile, so that a corresponding level-specific cooling level is obtained. Said walls with their cooling pipe coils are incorporated together into a coolant circuit, wherein the corresponding coolant distribution, by way of which the coolant that is to be conveyed through a lower level into an upper-lying level is distributed between the levels, is likewise provided outside of the housing, so that, consequently, also the connection points serving for coolant distribution between the levels all lie once again outside of the housing.

Additional advantages and details of the invention ensue from the exemplary embodiments described below as well as on the basis of the drawings. Shown are:

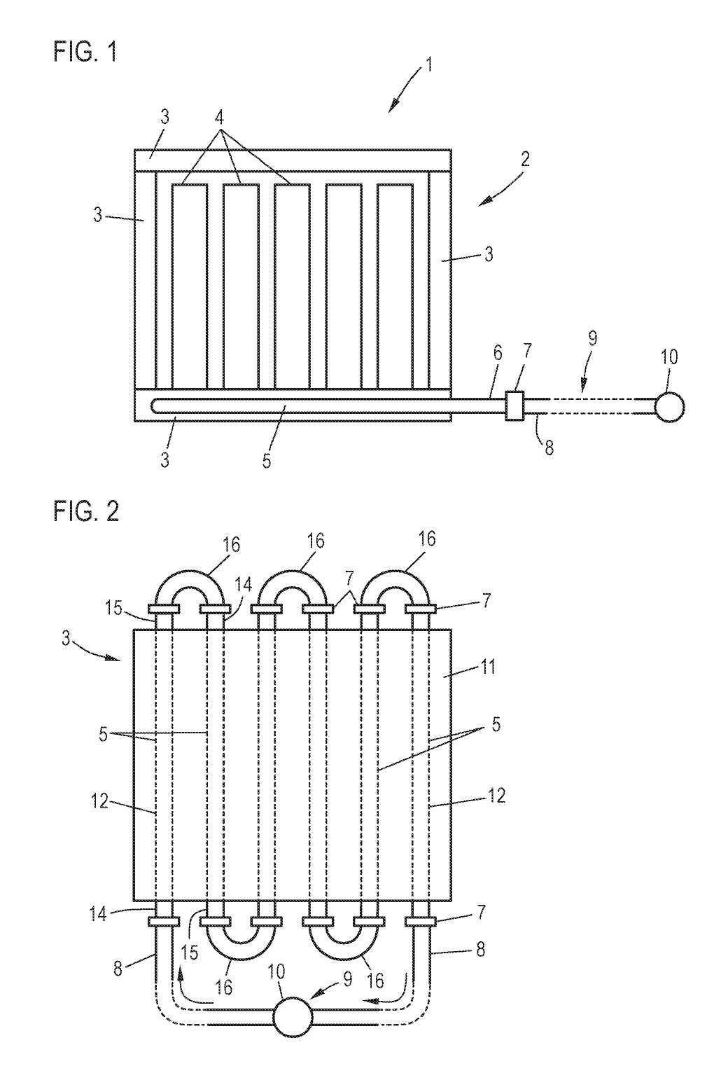

FIG. 1 a schematic illustration of an opened energy storage device together with a coolant circuit,

FIG. 2 a top view onto a coolable wall of the housing of the energy storage device of FIG. 1,

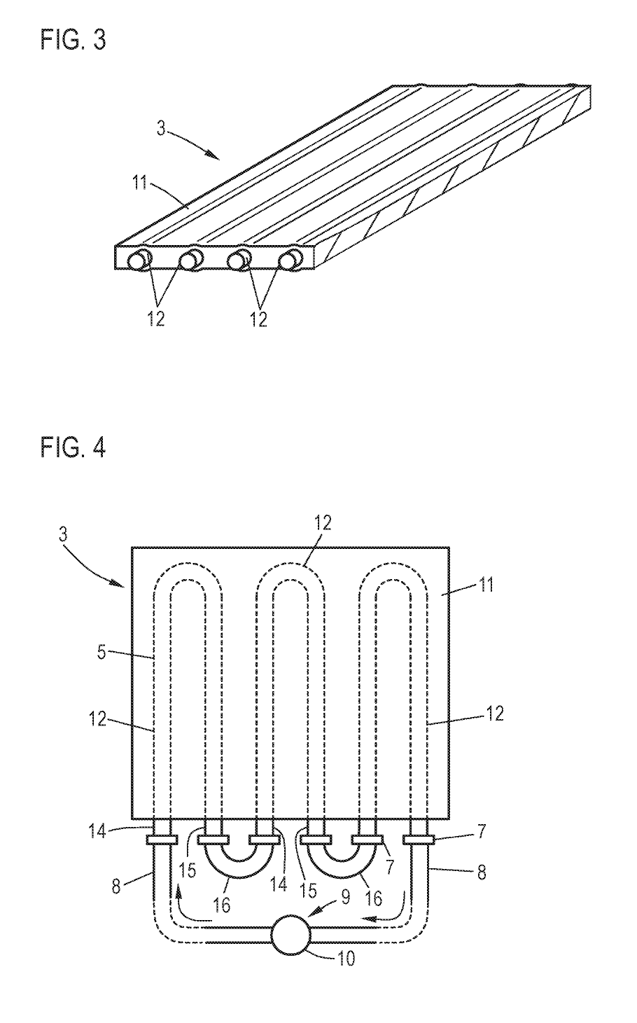

FIG. 3 a perspective partial view of the wall of FIG. 2,

FIG. 4 a top view onto a coolable wall of a housing of an energy storage device in accordance with a second embodiment,

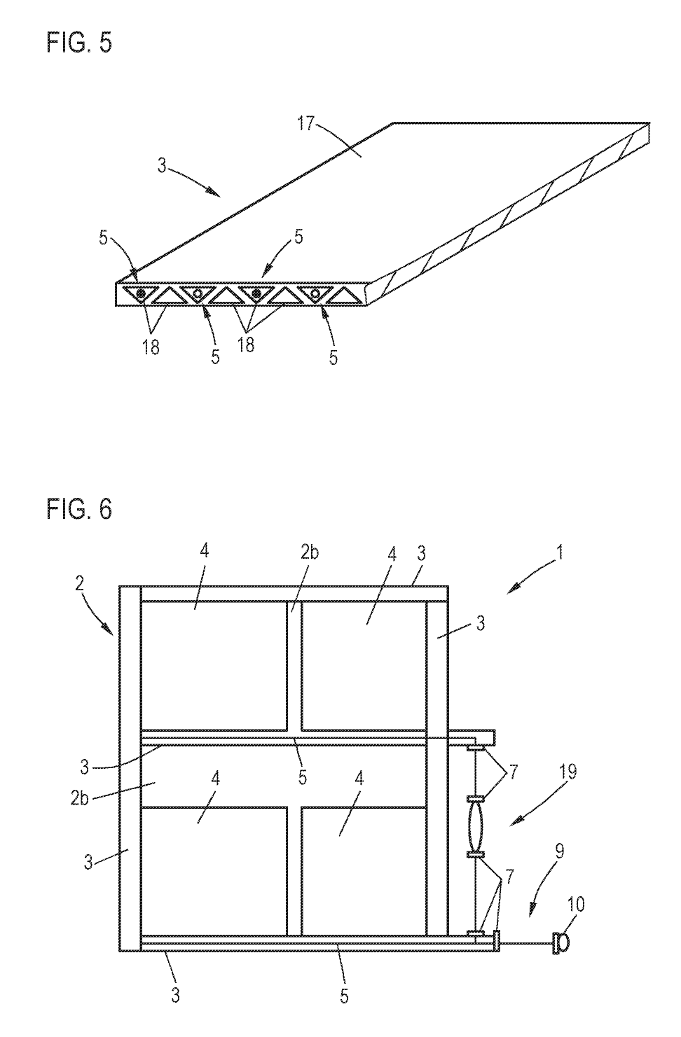

FIG. 5 a perspective view of a coolable wall of a third embodiment, and

FIG. 6 a schematic illustration of an energy storage device having a plurality of levels.

FIG. 1 shows a schematic illustration of an energy storage device 1 in accordance with the invention, which is shown opened here for purposes of explanation. It comprises a housing 2 with a plurality of walls 3, which are preferably composed of metal. In the interior of the housing 2, a plurality of storage cells or storage cell modules 4 are arranged and appropriately interconnected. The energy storage device 1 can be, for example, a high-voltage battery for a motor vehicle.

One of the walls 3—in the example shown, the bottom wall—can be actively cooled, for which purpose coolant lines 5 are integrated in the wall. The storage cells or storage modules 4 are thermally connected to this coolable bottom wall 3. The coolant lines 5 extend in the wall 3 without interruption and therefore without any connecting element or coupling element to another coolant line part and extend from an inlet connection to an outlet connection, both of which lie outside of the housing 2. Illustrated in the example shown is such an inlet connection 6, to which is connected, via a connecting element 7, another coolant line 8 of a coolant circuit 9, a pump 10 of which is shown as well. Owing to the fact that, inside of the housing, no coolant lines extend themselves whatsoever and no connection points whatsoever are present, any leakage of coolant in the interior of the housing is excluded.

FIG. 2 shows, in a first schematic illustration, an embodiment of such a wall 3. FIG. 3 shows, in addition, a perspective view of the wall 3. The wall 3 is, as described, a metal body 11, in which, in the example shown, the coolant lines 5 are formed by embedded pipes 12 made of metal. Each pipe 12 extends in a straight line through the wall 3 and therefore through the metal body 11 and, as FIG. 2 shows, the pipes are parallel to one another. For production of the wall 3, the pipes are placed in a corresponding casting mold and subsequently cast with the metal forming the metal body 11, so that a stable wall 3 with integrated pipes is obtained. Also conceivable would be a sandwich construction made up of two metal plates, between which the pipes 12 are laid or arranged.

In the example shown, the pipes 12 protrude somewhat through the respective front sides of the wall, but they can also be adjoined there flush. In the example shown, the two outer-lying pipes 12 are connected to corresponding coolant lines 8 of the coolant circuit 9. It is assumed that the coolant circulates, as indicated by the two arrows pointing toward the pump and away from the pump, respectively. The pipe 12 shown on the left consequently has an inlet connection 14 and, lying opposite to it, an outlet connection 15. The adjacent pipe 12 has, on this side, an inlet connection 14 and, on the opposite-lying side, an outlet connection 15. The individual inlet and outlet connections 14, 15 are connected to each other likewise via connecting pipe pieces 16 arranged outside of the housing 2, wherein, necessarily, in each case, an outlet connection 15 is connected to an inlet connection 14. In this way, it is possible to create a cooling coil or a cooling channel structure, each in a meandering shape. Obviously, each connection of a pipe 12 to a connecting pipe 16 is created via corresponding connecting or sealing means 7 and correspondingly sealed.

FIG. 4 shows an alternative embodiment of a wall 3, likewise comprising a metal body 11 with coolant lines 5 in the form of separate pipes 12 embedded or cast in it, which are bent here in a U-shape. In this case, the inlet and outlet connections 14, 15 all lie on a common side, as clearly shown in FIG. 4. The pipes 12, which are likewise made of a metal, such as preferably steel, are embedded in the metal body 11, so that, in turn, no connecting segments lie in the interior of the housing, but instead all connections created via the corresponding connecting elements 7 are provided outside of the housing. It can be seen here that, in this case, far fewer connecting pipe pieces 16 are needed, because the corresponding redirections are formed via the U-shaped pipes 12 themselves.

Instead of using one or a plurality of walls comprising the metal body 11 with the cast metal pipes 12, it is also conceivable for the formation of a wall 3 to use a plate-shaped extruded profile 17, such as shown in FIG. 5. This plate-shaped extruded profile 17 has a series of cavities 18, a part of which or all of which can be used as coolant lines 5. In the example shown, it is assumed that every second cavity 18 serves as a coolant line. The cavities 18 extend in a straight line and in parallel from one side of the extruded profile to the opposite-lying side and, in turn, are connected to one another via corresponding connecting pipe pieces, which are not shown in detail in FIG. 5. In FIG. 5, the respective flow direction is indicated by different symbols. A “●” symbol defines a flow direction into the cavity—that is, an inlet connection exists there—while a “◯” symbol defines an opposite flow direction and accordingly defines an outlet connection at this side. The connecting pipe pieces, in turn, are tightly connected to these cavities via corresponding connecting or sealing elements.

Even though, in FIG. 5, triangular cavities are shown by way of example, it is also obviously possible to create other cross-sectional shapes of cavities, such as, for example, a rectangular shape or a round shape.

Even though, in the schematic illustration in FIG. 1, only one wall 3 can be actively cooled, it would also obviously be conceivable to design a plurality of walls in this way. This enables an active multi-sided cooling of the housing.

Finally, FIG. 6 shows an energy storage device 1, comprising a larger housing 2, which, in turn, is composed of a plurality of walls 3, wherein, in this case, an intermediate wall 3 is provided, via which the housing 2 is divided into two housing sections 2a and 2b, so that, consequently, two levels are obtained, on which storage cells or storage cell modules 4 can be accommodated. In the example shown, corresponding storage cells or storage cell modules 4 are illustrated in the housing sections 2a, 2b. The respective walls 3 on which the storage cells or storage cell modules are placed are designed as actively coolable walls, in particular in one of the embodiments described above, and hence are equipped with cooling lines 5.

Also shown is the coolant circuit 9 with the pump 10, which is provided external to the housing and further leads to other coolant lines laid in the motor vehicle or is connected to each of them. In this case, the coolant circuit 9 comprises an additional coolant distribution 19, which makes it possible to distribute the coolant between the two levels, that is, between the lower wall 3 and the upper wall 3 or else between the coolant lines 5 thereof. What is involved, for example, is an additional connecting pipe, if appropriate with an integrated coolant reservoir, via which the end-side outlet connection of the wall 3 of the lower level is connected to a front-side inlet connection of the wall 3 of the upper level, or the equivalent. In any case, it is possible via such a coolant distribution 19, to distribute the coolant between the levels, so that said coolant needs to be fed solely into one side and again discharged on another side. In this case, too, the connecting and sealing means 7 are all arranged outside of the housing.

The energy storage device 1 can additionally have a plurality of such housing compartments and, consequently, also a plurality of levels, so that it is possible to provide even more actively coolable walls. It needs to be noted here that a wall that is to be actively cooled need not necessarily be an outer wall of the housing, but instead the wall can also be designed as a wall lying in the interior of a housing and with which the storage cells or storage cell modules are thermally coupled on one side or both sides.

1-17. (canceled)

8. An energy storage device comprising:
a housing with one or a plurality of storage cells or storage cell modules accommodated in it as well as one or a plurality of coolant lines, through which flows a coolant, flowing by way of a coolant circuit, wherein the one or the plurality of coolant lines is or are integrated in one or a plurality of walls of the housing and extends or extend without interruption, on the housing side, from an inlet connection lying outside of the housing to an outlet connection likewise lying outside of the housing.

9. The energy storage device according to claim 8, wherein the one or the plurality of coolant lines is or are formed by pipes, which are completely embedded in the one or the plurality of walls.

10. The energy storage device according to claim 9, wherein the pipes extend in the wall in a U-shape and open only at one side, wherein one of the pipe ends forms an inlet connection and the other pipe end forms an outlet connection, wherein the pipe ends of two pipes are connected to each other via connecting pipe pieces arranged outside of the housing.

11. The energy storage device according to claim 9, wherein the pipes extend in a straight line in the wall and are open at both sides, wherein one of the pipe ends forms an inlet connection and the other pipe end forms an outlet connection, wherein the pipe ends of two pipes are connected to each other via connecting pipe pieces arranged outside of the housing.

12. The energy storage device according to claim 8, wherein the walls are formed by extruded profiles with one or a plurality of cavities, wherein the cavity or cavities forms or form the coolant lines.

13. The energy storage device according to claim 12, wherein the cavities extend in a straight line in the extruded profile and one end of the cavity forms an inlet connection and the other end of the cavity forms an outlet connection, wherein the cavity ends of two cavities are connected to each other via connecting pipe pieces arranged outside of the housing.

14. The energy storage device according to claim 8, wherein the housing has a plurality of levels, in each of which one or a plurality of storage cells or storage cell modules is or are arranged, wherein, in each level, one or a plurality of coolant lines is or are provided, which are connected to one another outside of the housing via the coolant circuit.
